(19) United States
(12) Patent Application Publication
(10) Pub. No.: US 2022/0307744 A1
(43) Pub. Date: Sep. 29, 2022

(54) RESERVOIR TANK

(71) Applicants: TOYOTA JIDOSHA KABUSHIKI KAISHA, Toyota-shi Aichi-ken (JP); SUBARU CORPORATION, Tokyo (JP)

(72) Inventor: Hideo Nishioka, Toyota-shi Aichi-ken (JP)

(21) Appl. No.: 17/687,000

(22) Filed: Mar. 4, 2022

(30) Foreign Application Priority Data
Mar. 23, 2021 (JP) 2021-049128

(51) Int. Cl. F25B 43/04; F25B 43/00; B01D 19/00

(52) U.S. Cl. CPC F25B 43/04; F25B 43/006; B01D 19/0057

(57) ABSTRACT

A reservoir tank includes a first chamber, a second chamber, an inflow port coupled to the first chamber, an outflow port coupled to the second chamber, a partition wall provided to separate the first chamber and the second chamber from each other, and a refrigerant flow port provided in the partition wall to connect the first chamber and the second chamber to each other. When the reservoir tank is viewed in a plan view, at least a portion of a range of an inner wall of the first chamber facing the inflow port is curved in an arc shape.

### CROSS-REFERENCE TO RELATED APPLICATION

This application claims priority to Japanese Patent Application No. 2021-049128 filed on Mar. 23, 2021, incorporated herein by reference in its entirety.

### BACKGROUND

### 1. Technical Field

The disclosure relates to a reservoir tank.

### 2. Description of Related Art

Japanese Unexamined Patent Application Publication No. 2020-067082 (JP 2020-067082 A) discloses a reservoir tank. The reservoir tank has a cylindrical shape and includes a first chamber to which an inflow port is coupled, a second chamber to which an outflow port is coupled, and a partition wall separating the first chamber and the second chamber from each other. The first chamber and the second chamber are coupled to each other via a refrigerant flow port provided in the partition wall. The reservoir tank further includes a cylindrical swirling flow forming portion between the inflow port and the first chamber, and two holes coupled to the first chamber are provided on concentric circles of the swirling flow forming portion.

In the above-mentioned reservoir tank, by allowing the refrigerant to flow into the first chamber through two holes provided on the concentric circles of the swirling flow forming portion, the swirling flow is generated in the refrigerant in the reservoir tank. In this way, air bubbles are removed from the refrigerant flowing into the reservoir tank.

### SUMMARY

In the above-mentioned configuration, the reservoir tank having a cylindrical shape is employed to generate a swirling flow in the refrigerant in the reservoir tank. In the above-mentioned reservoir tank, the shape of the reservoir tank is limited to a cylindrical shape, which requires a relatively large space for disposing the reservoir tank. In addition to this, in order to increase the amount of the refrigerant staying in the reservoir tank, it is conceivable to put the reservoir tank into a long cylindrical shape or a cylindrical shape having a large diameter. Even in this case, the space for disposing the reservoir tank becomes larger than necessary. Therefore, in order to avoid the space for disposing the reservoir tank becoming unnecessarily larger, there is a demand for a reservoir tank that generates a swirling flow of refrigerant therein without having a cylindrical shape.

The disclosure has been made in view of the above circumstances, and provides a technique capable of generating a swirling flow of refrigerant in a reservoir tank without necessarily demanding a cylindrical shape.

An aspect of the disclosure relates to a reservoir tank. The reservoir tank includes a first chamber, a second chamber, an inflow port coupled to the first chamber; an outflow port coupled to the second chamber, a partition wall provided to separate the first chamber and the second chamber from each other, and a refrigerant flow port provided in the partition wall to connect the first chamber and the second chamber to each other. When the reservoir tank is viewed in a plan view, at least a portion of a range of an inner wall of the first chamber facing the inflow port is curved in an arc shape.

In the reservoir tank, when the reservoir tank is viewed in a plan view, at least a portion of the range of the inner wall facing the inflow port in the first chamber coupled to the inflow port is curved in an arc shape. With the configuration, the refrigerant flows toward the inner wall of the first chamber after flowing in from the inflow port. In the range facing the inflow port, the inner wall of the first chamber is curved in an arc shape, and thus the refrigerant reaching the inner wall changes the direction along the curved inner wall. Accordingly, a swirling flow is generated in the refrigerant in the first chamber. Due to the swirling flow, centrifugal force acts on the refrigerant in the first chamber, and air bubbles contained in the refrigerant move toward the center of swirling. As a result, even fine air bubbles that make the refrigerant cloudy, for example, can be separated from the refrigerant by binding the air bubbles to each other to form particles. Then, the refrigerant flows from the first chamber to the second chamber via the refrigerant flow port, and the particle-formed air bubbles are removed from the refrigerant in the second chamber. In this way, it is possible to generate a swirling flow in the refrigerant in the reservoir tank without necessarily putting the shape of the reservoir tank into a cylindrical shape, whereby it is possible to effectively separate the air bubbles contained in the refrigerant. As a result, it is possible to avoid the space for disposing the reservoir tank becoming larger unnecessarily.

In the aspect, a radius of curvature of the inner wall of the first chamber curved in an arc shape may be larger than a radius of the inflow port. With the configuration, of the inner wall of the first chamber, at least the range facing the inflow port can be curved in an arc shape as a whole. As a result, more of the refrigerant flowing into the first chamber from the inflow port is guided along the inner wall curved in an arc shape to generate a swirling flow.

In the aspect, the inflow port may be provided above the refrigerant flow port. In other words, the refrigerant flow port may be provided below the inflow port. With the configuration, the refrigerant flowing into the first chamber from the inflow port flows into the second chamber through the refrigerant flow port provided below the inflow port. At this time, the air bubbles contained in the refrigerant tend to rise due to the buoyancy against the refrigerant flowing downward. As a result, the air bubbles contained in the refrigerant stay in the first chamber for a long time, and the separation of the air bubbles by the swirling flow functions effectively.

In the aspect, a cross-sectional area perpendicular to a vertical direction of the first chamber at a height position of the inflow port may be larger than a cross-sectional area perpendicular to the vertical direction of the first chamber at a height position of the refrigerant flow port. With the above-mentioned configuration, the radius of the swirling flow at the height position of the refrigerant flow port is smaller than that at the height position of the inflow port. Therefore, at the height position of the refrigerant flow port, the centrifugal force generated in the refrigerant is larger than that at the height position of the inflow port, and thus air bubbles can be effectively separated from the refrigerant. Further, in the swirling flow formed in the first chamber, the swirling speed is gradually increased along the flow of the refrigerant from the inflow port to the refrigerant flow port. The swirling flow is likely to be stably formed, and the particle formation of air bubbles is effectively promoted.

In the aspect, the cross-sectional area perpendicular to the vertical direction of the first chamber at the height position of the inflow port may be larger than twice the cross-sectional area perpendicular to the vertical direction of the first chamber at the height position of the refrigerant flow port. With the configuration, in the swirling flow formed in the first chamber, the radius of swirling at the height position of the refrigerant flow port can be made sufficiently smaller than the radius of swirling at the height position of the inflow port. As a result, at the height position of the refrigerant flow port, the centrifugal force generated in the refrigerant can be sufficiently increased, and thus it is possible to more effectively separate air bubbles from the refrigerant.

In the aspect, the cross-sectional area perpendicular to the vertical direction of the first chamber may be changed to become smaller toward a lower side in at least a part between the height position of the inflow port and the height position of the refrigerant flow port. In this case, the cross-sectional area perpendicular to the vertical direction of the first chamber may be decreased stepwise or continuously between the height position of the inflow port and the height position of the refrigerant flow port. With the above-mentioned configuration, in the swirling flow formed in the first chamber, the swirling speed is changed smoothly along the vertical direction, and thus the swirling flow of the refrigerant is stable and the particle formation of air bubbles is further promoted.

In the aspect, a volume of the first chamber may be smaller than a volume of the second chamber. With the above-mentioned configuration, the time that the refrigerant stays in the second chamber is longer than the time that the refrigerant stays in the first chamber. Air bubbles are removed from the refrigerant in the second chamber, and thus it is possible to sufficiently remove air bubbles from the refrigerant by prolonging the time that the refrigerant stays in the second chamber.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a reservoir tank of an embodiment;

FIG. 2 is a cross-sectional view taken along plane II-II of FIG. 1;

FIG. 3 is a cross-sectional view taken along line of FIG. 2;

FIG. 4 is a diagram illustrating a behavior of a refrigerant and air bubbles in FIG. 2; and

FIG. 5 is a diagram illustrating a behavior of a refrigerant in FIG. 3.

### DETAILED DESCRIPTION OF EMBODIMENTS

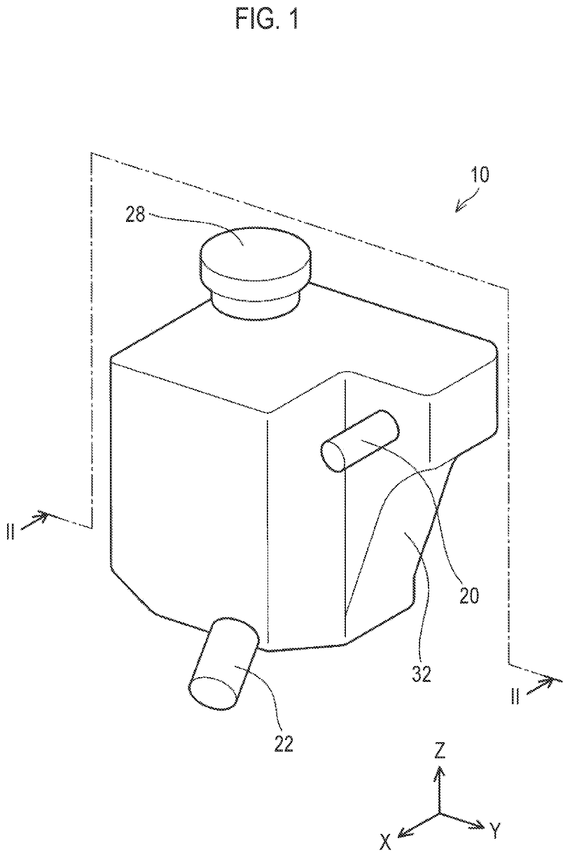

A reservoir tank 10 of an embodiment will be described with reference to the drawings. The reservoir tank 10 of the embodiment is provided in a circuit in which a refrigerant (also referred to as a “heat medium”), such as coolant, circulates. When the refrigerant 80 flows in and out of the circuit, the reservoir tank 10 stores surplus refrigerant 80 and removes air bubbles 70 from the refrigerant 80. As an example, the reservoir tank 10 can be used in a vehicle thermal management system. In this case, in the reservoir tank 10, the air bubbles 70 are removed from the refrigerant 80 when the refrigerant 80 that cools each part of the vehicle flows in and out. Although not particularly limited, the reservoir tank 10 is made of resin. In the following, as illustrated in FIG. 1, a vertically upward direction indicates a Z direction, one direction parallel to a horizontal plane indicates an X direction, and a direction parallel to the horizontal plane and orthogonal to the X direction indicates a Y direction.

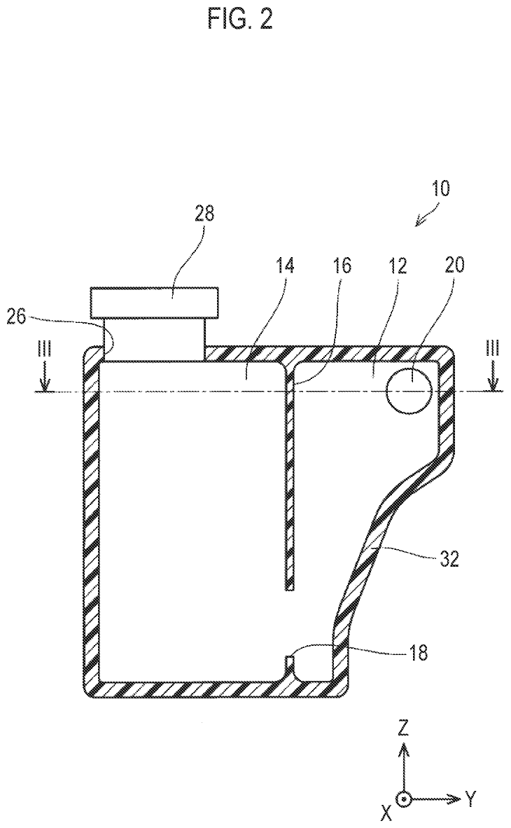

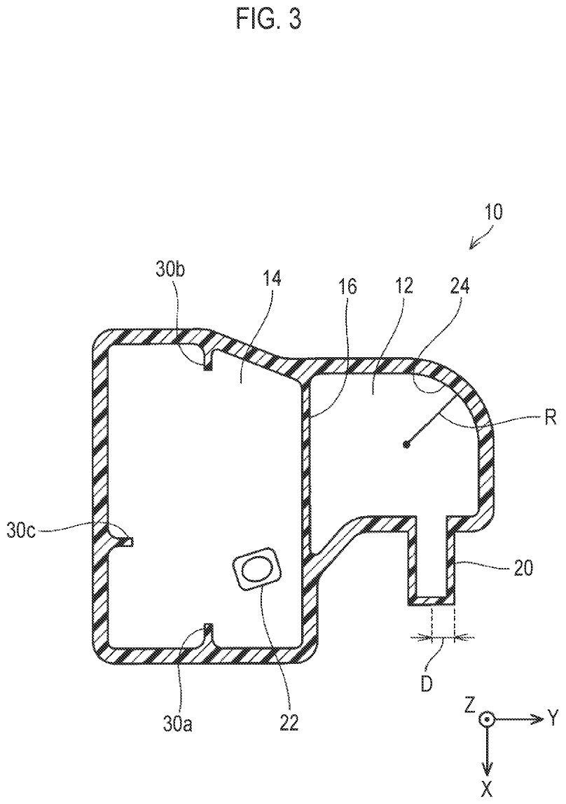

As illustrated in FIGS. 2 and 3, the reservoir tank 10 includes a first chamber 12, a second chamber 14, and a partition wall 16. The partition wall 16 is provided inside the reservoir tank 10. The partition wall 16 divides the internal space of the reservoir tank 10 into the first chamber 12 and the second chamber 14. The first chamber 12 is adjacent to the second chamber 14 in the Y direction with the partition wall 16 in between. Each of the first chamber 12 and the second chamber 14 has a long shape in the Z direction. In the reservoir tank 10 of the embodiment, the volume of the first chamber 12 is smaller than the volume of the second chamber 14. As another embodiment, the volume of the first chamber 12 does not necessarily have to be smaller than the volume of the second chamber 14, and may be equal to the volume of the second chamber 14 or larger than the volume of the second chamber 14.

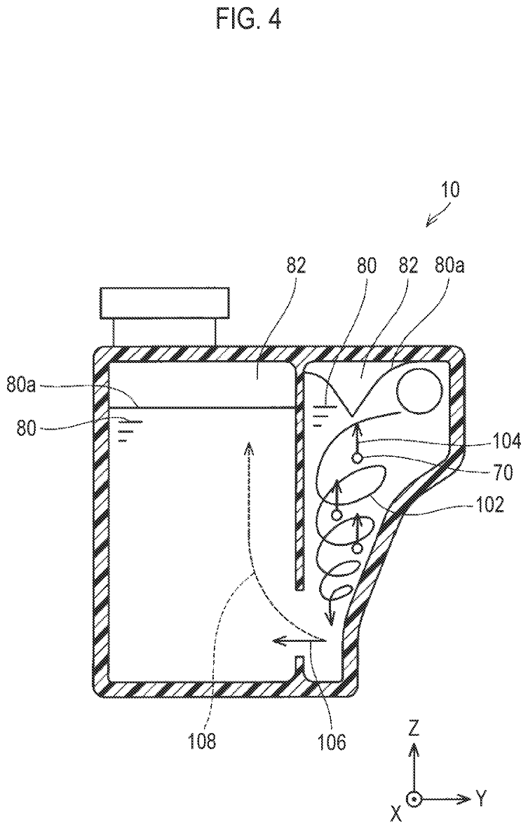

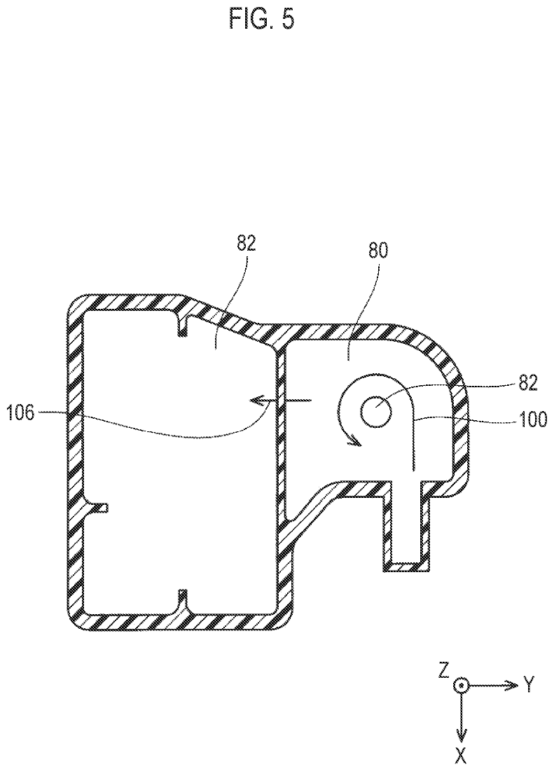

As illustrated in FIGS. 4 and 5, each of the first chamber 12 and the second chamber 14 stores the refrigerant 80. In each of the first chamber 12 and the second chamber 14, a liquid level 80a of the refrigerant 80 exists at a position lower than the ceiling of each of the chambers 12 and 14. In each of the first chamber 12 and the second chamber 14, air 82 exists in the space above the liquid level 80a. As illustrated in FIGS. 2 to 5, the partition wall 16 is provided with a refrigerant flow port 18 that connects the first chamber 12 and the second chamber 14 to each other. The refrigerant flow port 18 is disposed below the liquid level 80a of the refrigerant 80. In this way, the refrigerant 80 can flow between the first chamber 12 and the second chamber 14 via the refrigerant flow port 18.

As illustrated in FIGS. 2 and 3, the reservoir tank 10 further includes an inflow port 20 and an outflow port 22. The inflow port 20 is coupled to the first chamber 12, and the outflow port 22 is coupled to the second chamber 14. A refrigerant supply pipe (not illustrated) is coupled to the inflow port 20 of the first chamber 12. Therefore, the refrigerant 80 can flow in from the refrigerant supply pipe to the first chamber 12 via the inflow port 20. Similarly, a refrigerant discharge pipe (not illustrated) is coupled to the outflow port 22 of the second chamber 14. Therefore, the refrigerant 80 can flow out from the second chamber 14 to the refrigerant discharge pipe via the outflow port 22. Therefore, the refrigerant 80 flowing in from the inflow port 20 of the reservoir tank 10 flows out from the outflow port 22 of the reservoir tank 10 via the first chamber 12, the refrigerant flow port 18, and the second chamber 14 in this order. The refrigerant supply pipe and the refrigerant discharge pipe are provided with a device which is a target to be cooled by the refrigerant 80, a heat exchanger for cooling the refrigerant 80, a pump for circulating the refrigerant 80, and the like (all not illustrated).

As illustrated in FIG. 3, a guide portion 24 is provided on the inner wall of the first chamber 12. The guide portion 24 guides the refrigerant 80 flowing in from the inflow port 20 in a direction along the inner wall of the first chamber 12 to generate a swirling flow in the first chamber 12. The guide portion 24 is disposed at a position at which the inflow port 20 is faced, when the reservoir tank 10 is viewed in a plan view, that is, in an x-y plane. The guide portion 24 is curved in an arc shape. As an example, the guide portion 24 curved in an arc shape has a predetermined radius of curvature R. Although not particularly limited, the radius of curvature R of the guide portion 24 may be larger than a radius D of the inflow port 20. The guide portion 24 curved in an arc shape does not necessarily have to have the predetermined radius of curvature R. That is, as another embodiment, the guide portion 24 curved in an arc shape may be provided on at least a portion of the inner wall of the first chamber 12.

As illustrated in FIG. 2, the second chamber 14 includes a through port 26 and a pressure adjusting lid 28. The through port 26 is disposed above the liquid level 80a of the refrigerant 80. Therefore, the air 82 can move between the inside of the second chamber 14 and the outside of the second chamber 14 (that is, the outside of the reservoir tank 10) via the through port 26. The pressure adjusting lid 28 is detachably attached to the through port 26. The pressure adjusting lid 28 has a configuration for adjusting the pressure in the reservoir tank 10. As an example, when the pressure of the air 82 in the second chamber 14 becomes higher than a first threshold value, the pressure adjusting lid 28 opens an adjusting valve to allow the air 82 in the reservoir tank 10 to be discharged outside through the through port 26. Therefore, the air bubbles 70 removed from the refrigerant 80 in the second chamber 14 can be discharged outside the reservoir tank 10 through the through port 26. The specific configuration of the through port 26 and the pressure adjusting lid 28 is not particularly limited.

As illustrated in FIG. 3, the second chamber 14 includes a plurality of ribs 30. As an example, the ribs 30 include a first rib 30a, a second rib 30b, and a third rib 30c. The ribs 30 are provided on the inner wall of the second chamber 14. The ribs 30 increase the strength of the wall surface of the reservoir tank 10. In addition, the ribs 30 need not necessarily be provided in the second chamber 14. For example, when the strength of the wall surface of the reservoir tank 10 can be sufficiently maintained by the shape, the volume, or the like of the second chamber 14, the ribs 30 need not be installed. Further, the ribs 30 may be provided in the first chamber 12 instead of or in addition to the second chamber 14.

Next, the action and effect of the reservoir tank 10 will be described with reference to FIGS. 4 and 5. In the reservoir tank 10, when the reservoir tank 10 is viewed in a plan view, the guide portion 24 facing the inflow port 20 in the first chamber 12 coupled to the inflow port 20 is curved in an arc shape. With the above-mentioned configuration, the refrigerant 80 flows in from the inflow port 20 and then flows toward the guide portion 24 of the first chamber 12. In the guide portion 24 facing the inflow port 20, the inner wall of the first chamber 12 is curved in an arc shape, and thus the refrigerant 80 reaching the guide portion 24 changes its direction along the curved inner wall. As a result, a swirling flow is generated in the refrigerant 80 in the first chamber 12 (see arrow 100 in FIG. 5). Due to the swirling flow, centrifugal force acts on the refrigerant 80 in the first chamber 12, and air bubbles 70 contained in the refrigerant move toward the center of swirling. As a result, even fine air bubbles 70 that make the refrigerant 80 cloudy, for example, can be separated from the refrigerant 80 by binding the air bubbles to each other to form particles. Then, the refrigerant 80 flows from the first chamber 12 into the second chamber 14 via the refrigerant flow port 18 (see arrow 106 in FIG. 4). Then, in the second chamber 14, the particle-formed air bubbles 70 are removed from the refrigerant 80 (see arrow 108 in FIG. 4). In this way, it is possible to generate a swirling flow in the refrigerant 80 in the reservoir tank 10 without necessarily putting the shape of the reservoir tank 10 into a cylindrical shape, whereby it is possible to effectively separate the air bubbles 70 contained in the refrigerant 80. As a result, it is possible to avoid the space for disposing the reservoir tank 10 becoming larger unnecessarily.

As an example, in the reservoir tank 10 of the embodiment, the inflow port 20 is provided above the refrigerant flow port 18, as illustrated in FIG. 2. With the configuration, the refrigerant 80 flowing into the first chamber 12 from the inflow port 20 flows into the second chamber 14 through the refrigerant flow port 18 provided below the inflow port 20. At this time, the air bubbles 70 contained in the refrigerant 80 tend to rise due to the buoyancy against the refrigerant 80 flowing downward (see arrow 104 in FIG. 4). As a result, the air bubbles 70 contained in the refrigerant 80 stay in the first chamber 12 for a long time, and the separation of the air bubbles 70 by the swirling flow functions effectively.

As an example, as illustrated in FIG. 2, in the reservoir tank 10 of the embodiment, a wall surface 32 of the first chamber 12 is located to be further inward (that is, a —Y direction) toward a lower side in a part between the height position of the inflow port 20 and the height position of the refrigerant flow port 18. In other words, the cross-sectional area perpendicular to the vertical direction of the first chamber 12 is changed to become smaller toward the lower side in a part between the height position of the inflow port 20 and the height position of the refrigerant flow port 18. With the configuration, the radius of the swirling flow becomes smaller toward the lower side in a part between the height of the inflow port 20 and the height of the refrigerant flow port 18 (see arrow 102 in FIG. 4). Therefore, at the height position of the refrigerant flow port 18, the centrifugal force generated in the refrigerant 80 becomes large, and thus the air bubbles 70 can be effectively separated from the refrigerant 80. Further, in the swirling flow formed in the first chamber 12, the swirling speed is gradually increased along the flow of the refrigerant 80 from the inflow port 20 to the refrigerant flow port 18. The swirling flow is likely to be stably formed, and the particle formation of air bubbles 70 is effectively promoted. The cross-sectional area perpendicular to the vertical direction of the first chamber 12 may be decreased stepwise or continuously in a part between the height position of the inflow port 20 and the height position of the refrigerant flow port 18.

In place of or in addition to the above embodiment, the cross-sectional area perpendicular to the vertical direction of the first chamber 12 at the height position of the inflow port 20 may be larger than twice the cross-sectional area perpendicular to the vertical direction of the first chamber 12 at the height position of the refrigerant flow port 18. With the configuration, in the swirling flow formed in the first chamber 12, the radius of swirling at the height position of the refrigerant flow port 18 can be made sufficiently smaller than the radius of swirling at the height position of the inflow port 20. As a result, at the height position of the refrigerant flow port 18, the centrifugal force generated in the refrigerant 80 can be sufficiently increased, and thus it is possible to more effectively separate air bubbles 70 from the refrigerant 80.

Although some specific examples have been described in detail above, these are merely examples and do not limit the scope of claims. The techniques described in the claims include various modifications and changes of the specific examples illustrated above. The technical elements described herein or in the drawings exhibit their technical usefulness alone or in combination.

What is claimed is:

1. A reservoir tank comprising:
a first chamber;
a second chamber;
an inflow port coupled to the first chamber;
an outflow port coupled to the second chamber;
a partition wall provided to separate the first chamber and the second chamber from each other; and
a refrigerant flow port provided in the partition wall to connect the first chamber and the second chamber to each other,
wherein when the reservoir tank is viewed in a plan view, at least a portion of a range of an inner wall of the first chamber facing the inflow port is curved in an arc shape.

2. The reservoir tank according to claim 1, wherein a radius of curvature of the inner wall curved in the arc shape is larger than a radius of the inflow port.

3. The reservoir tank according to claim 1, wherein the inflow port is provided above the refrigerant flow port.

4. The reservoir tank according to claim 3, wherein a cross-sectional area perpendicular to a vertical direction of the first chamber at a height position of the inflow port is larger than a cross-sectional area perpendicular to the vertical direction of the first chamber at a height position of the refrigerant flow port.

5. The reservoir tank according to claim 4, wherein the cross-sectional area perpendicular to the vertical direction of the first chamber at the height position of the inflow port is larger than twice the cross-sectional area perpendicular to the vertical direction of the first chamber at the height position of the refrigerant flow port.

6. The reservoir tank according to claim 4, wherein the cross-sectional area perpendicular to the vertical direction of the first chamber is changed to become smaller toward a lower side in at least a part between the height position of the inflow port and the height position of the refrigerant flow port.

7. The reservoir tank according to any one of claim 1, wherein a volume of the first chamber is smaller than a volume of the second chamber.
